(19) United States
(12) Patent Application Publication
(10) Pub. No.: US 2026/0338017 A1
(43) Pub. Date: Oct. 29, 2026

(54) DOOR RETAINER ASSEMBLY FOR VEHICLE SERVICE BODY

(71) Applicant: The Knapheide Manufacturing Company, Quincy, IL (US)

(72) Inventors: Justin Steele, Quincy, IL (US); Michael Land, Quincy, IL (US)

(73) Assignee: The Knapheide Manufacturing Company, Quincy, IL (US)

(21) Appl. No.: 19/337,086

(22) Filed: Sep. 23, 2025

Related U.S. Application Data
(60) Provisional application No. 63/697,932, filed on Sep. 23, 2024.

(51) Int. Cl. E05C 17/18

(52) U.S. Cl. CPC E05C 17/18

(57) ABSTRACT

A door retainer assembly includes a door bracket configured to be mounted to a door of a service body, a pivot base configured to be mounted to a doorframe of the service body, and a check assembly configured to be removably attached to the door bracket via a rod bushing and the pivot base via a pivot mount. The check assembly is configured to selectively hold the door of the service body in an open position. The rod bushing comprises a dual release bushing so that the rod of the check assembly can be independently removed from the rod bushing even when the rod bushing is mounted in the door bracket and so that the rod bushing can be removed from the door bracket with the rod still attached to the rod bushing.

### CROSS-REFERENCE TO RELATED APPLICATIONS

This patent application claims the benefit of priority to U.S. Provisional Patent Application No. 63/697,932, filed Sep. 23, 2024, and entitled, “Door Retainer Assembly for Vehicle Service Body,” which is incorporated in its entirety herein by this reference.

### TECHNICAL FIELD

This patent disclosure relates generally to a door retainer assembly and, more particularly, to a door retainer assembly for a service body suitable for use with a variety of vehicles.

### BACKGROUND

A service body configured for use by a tradesman can be added to a vehicle to enhance its usefulness for safely storing equipment commonly used by the tradesman in carrying out his vocation. The service body includes a variety of storage spaces accessible via one or more doors. In use, it can be helpful for the door to remain propped open to provide the tradesman sustained access to the interior storage space without having to move the door to the open position before gaining access.

There is a continued need in the art to provide additional solutions to enhance the use and manufacture of service bodies for vehicles. For example, there is a continued need for a door retainer assembly that can be readily installed for day-to-day use and removed for operations such as painting/powder coating the service body.

It will be appreciated that this background description has been provided to aid the reader, and is not to be taken as an indication that any of the indicated problems were themselves appreciated in the art. While the described principles can, in some aspects and embodiments, alleviate the problems inherent in other systems, it will be appreciated that the scope of the protected innovation is defined by the attached claims, and not by the ability of any disclosed feature to solve any specific problem noted herein.

### SUMMARY

The present disclosure, in one aspect, is directed to embodiments of a door retainer assembly. In embodiments, a door retainer assembly includes a door bracket for mounting to a door of a service body, a pivot base for mounting to a doorframe of the service body, and a check assembly configured to be removably attached to the door bracket and the pivot base.

In still another aspect, embodiments of a service body for a vehicle are disclosed. In embodiments, a service body includes an embodiment of a door retainer assembly constructed according to principles of the present disclosure.

In one embodiment, a service body for a vehicle includes an enclosure, a door, and a door retainer assembly. The enclosure includes a doorframe that defines an enclosure opening. The door is rotatably mounted to the doorframe so that the door is movable between an open position and a closed position in which it covers at least a portion of the enclosure opening. The door retainer assembly includes a door bracket mounted to the door, a pivot base mounted to the doorframe, and a check assembly removably attached to the door bracket and the pivot base.

Further and alternative aspects and features of the disclosed principles will be appreciated from the following detailed description and the accompanying drawings. As will be appreciated, the door retainer assemblies and vehicle service bodies disclosed herein are capable of being carried out in other and different embodiments, and capable of being modified in various respects. Accordingly, it is to be understood that both the foregoing general description and the following detailed description are exemplary and explanatory only and do not restrict the scope of the appended claims.

### BRIEF DESCRIPTION OF THE DRAWINGS

FIG. 1 is an exploded view of an embodiment of a door retainer assembly constructed in accordance with principles of the present disclosure, the door retainer assembly including a door bracket, a pivot base, and a check assembly.

FIG. 2 is a perspective view of the door bracket of the door retainer assembly of FIG. 1.

FIG. 3 is a perspective view of the pivot base of the door retainer assembly of FIG. 1.

FIG. 4 is an elevational view of the check assembly of the door retainer assembly of FIG. 1.

FIG. 5 is bottom plan view of a rod bushing of the check assembly of the door retainer assembly of FIG. 1.

FIG. 6 is a bottom perspective view of the rod bushing of FIG. 5.

FIG. 7 is a top perspective view of the rod bushing of FIG. 5.

FIG. 8 is a fragmentary perspective view of a bracket end of the check assembly of FIG. 4, illustrating the rod bushing mounted to a rod of the check assembly.

FIG. 9 is a view as in FIG. 8, but as an exploded view.

FIG. 10 is a fragmentary longitudinal sectional view of the bracket end of the check assembly of FIG. 4.

FIG. 11 is a view as in FIG. 10, but as a first perspective from below.

FIG. 12 is a view as in FIG. 8, but as a second perspective from above.

FIG. 13 is a top plan view of the pivot base of the door retainer assembly of FIG. 1.

FIG. 14 is a perspective view of the pivot base of FIG. 13.

FIG. 15 is a first end elevational view of the pivot base of FIG. 13.

FIG. 16 is a second end elevational view of the pivot base of FIG. 13.

FIG. 17 is a side elevational view of the pivot base of FIG. 13.

FIG. 18 is a cross sectional view of the pivot base of FIG. 13 taken along line XVIII-XVIII in FIG. 15.

FIG. 19 is a view as in FIG. 18, but as a first perspective view from the first end.

FIG. 20 is a view as in FIG. 18, but as a second perspective view from the second end.

FIG. 21 is a perspective view of a portion of an embodiment of a service body constructed in accordance with principles of the present disclosure with the door retainer assembly of FIG. 1 mounted thereto.

FIG. 22 is an enlarged detail view of the service body of FIG. 21.

FIG. 23 is a view similar to FIG. 22, but with the check assembly of the door retainer assembly of FIG. 1 removed.

FIG. 24 is a fragmentary sectional view, in perspective, of a door suitable for use with a service body constructed in accordance with principles of the present disclosure illustrating the door bracket mounted thereto via a support plate.

FIG. 25 is a view as in FIG. 24, but in elevation.

FIGS. 26 and 27 are enlarged views similar to FIG. 22, illustrating a first attachment sequence of the bracket end of the check assembly to the door bracket, which is mounted to a door of the service body.

FIGS. 28 and 29 are side elevational views illustrating a first detachment sequence of the bracket end of the check assembly from the bracket of the door retainer assembly of FIG. 1.

FIGS. 30 and 31 are enlarged views similar to FIG. 22, illustrating a second attachment sequence of the bracket end of the check assembly to the bracket of the door retainer assembly of FIG. 1, which is mounted to a door of the service body.

FIGS. 32 and 33 are side elevational views illustrating a second detachment sequence of the bracket end of the check assembly from the bracket of the door retainer assembly of FIG. 1.

FIGS. 34 and 35 are fragmentary perspective views illustrating an attachment sequence of a pivot mount of the check assembly to the pivot base of the door retainer assembly of FIG. 1, which is mounted to a doorframe of the service body.

FIGS. 36-38 are detail views illustrating the attachment sequence of the pivot mount of the check assembly to the pivot base of the door retainer assembly of FIG. 1, which is mounted to the doorframe of the service body.

FIG. 39 is an enlarged detail view of the pivot mount of the check assembly mounted to the pivot base of the door retainer assembly of FIG. 1, which is mounted to the doorframe of the service body.

FIGS. 40 and 41 are detail views similar to FIG. 39, but illustrating a detachment sequence of the pivot mount of the check assembly from the pivot base of the door retainer assembly of FIG. 1, which is mounted to the doorframe of the service body.

It should be understood that the drawings are not necessarily to scale and that disclosed embodiments are illustrated diagrammatically and in partial views. In certain instances, details which are not necessary for an understanding of this disclosure or which render other details difficult to perceive may have been omitted. It should be understood that this disclosure is not limited to the particular embodiments illustrated herein.

### DETAILED DESCRIPTION OF EXEMPLARY EMBODIMENTS

Embodiments of a door retainer assembly constructed in accordance with principles of the present disclosure can be configured to be used with at least one door of a service body for a vehicle. Embodiments of a door retainer assembly constructed in accordance with principles of the present disclosure can be used to hold in an open position a door of an after-market service body which is mounted to a vehicle to permit access to an interior storage area defined by the service body.

Embodiments of a door retainer assembly constructed in accordance with principles of the present disclosure can include a door bracket for mounting to a door of the service body, a pivot base for mounting to a doorframe of the service body, and a check assembly for selectively holding the door in an open position. In embodiments, the check assembly is attached to both the door bracket and the pivot base. In embodiments, the check assembly can be removably attached to both the door bracket and the pivot base to allow the check assembly to be removed during various processes. For example, in embodiments, the check assembly can be removed from the door bracket and the pivot base to allow the service body to be painted or powder coated, for example. Embodiments of a door retainer assembly constructed in accordance with principles of the present disclosure can have a wide variety of different forms, as will be appreciated by one skilled in the art.

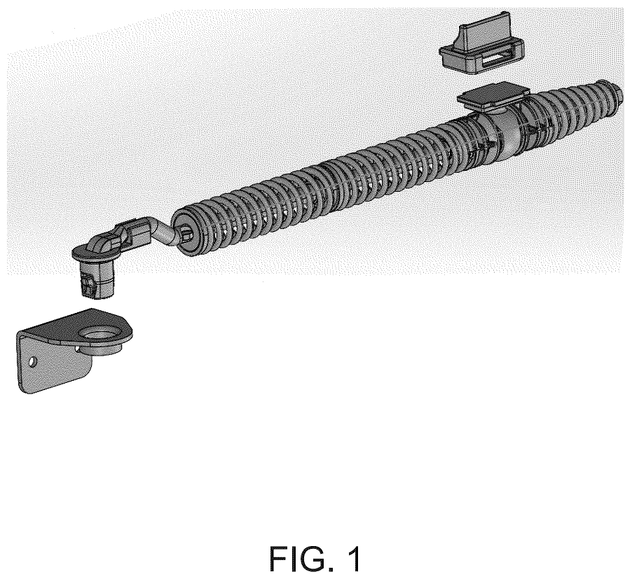

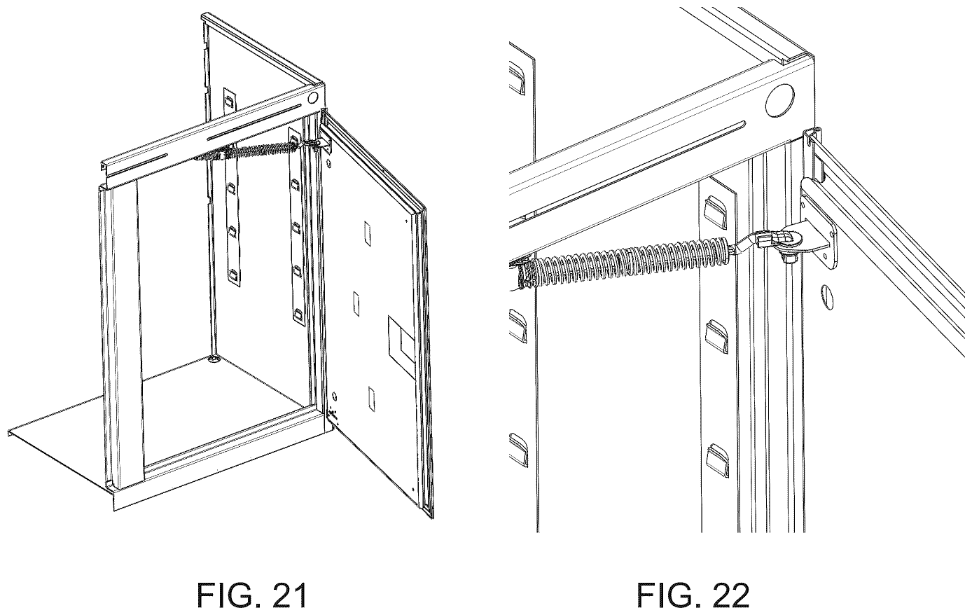

Turning now to the Figures, there is shown in FIG. 1 an embodiment of a door retainer assembly 50 constructed according to principles of the present disclosure. The illustrated door retainer assembly 50 includes a door bracket 52 configured to be mounted to a door 53 of a service body 54, a pivot base 55 configured to be mounted to a doorframe 56 of the service body 54, and a check assembly 57 configured to be removably attached to the door bracket 52 and the pivot base 55 (see also FIG. 21). The check assembly 57 is configured to selectively hold the door 53 of the service body 54 in an open position, as shown in FIG. 21.

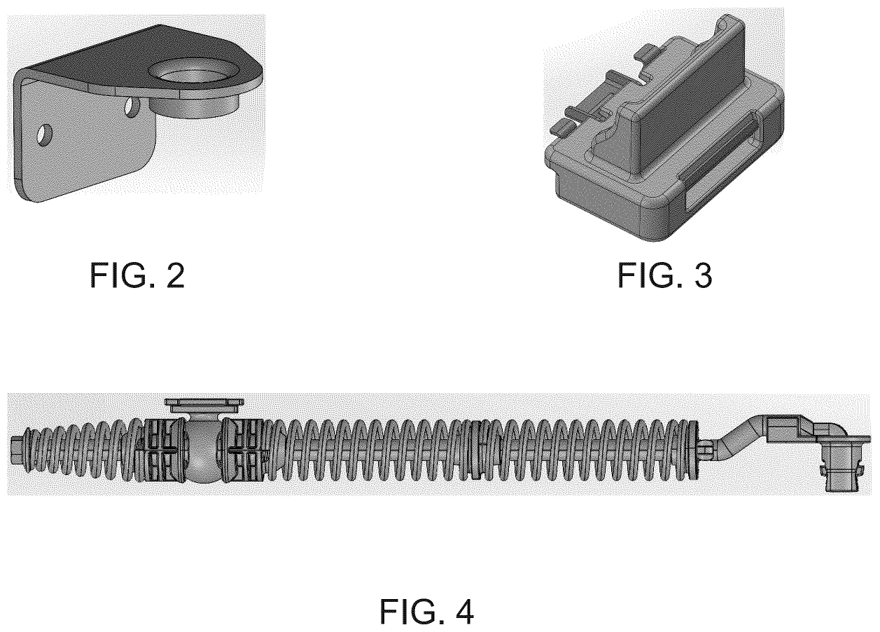

Referring to FIG. 2, the illustrated door bracket 52 comprises a generally L-shaped bracket that includes a door mounting flange 62, a rod mounting flange 64 projecting from an end 65 of the door mounting flange 62, and a collar 67 extending from the rod mounting flange 64. The door mounting flange 62 is configured to be applied against an interior surface 69 of the door 53 of the service body 54 and suitable for securing the door bracket 52 to the door 53 (see also FIG. 22). The door mounting flange 62 defines a plurality of mounting holes 70 through which suitable fasteners 71 can respectively extend for mounting the door bracket 52 to the door. In embodiments, any suitable technique can be used to mount the door bracket 52 to the door. The rod mounting flange 64 defines a bushing opening 74 that is in communication with a bushing passage 75 defined by the collar 67.

The rod mounting flange 64 and the collar 67 cooperate together to removably secure the check assembly 57 to the door bracket 52. In embodiments, a bent rod end 80 of the check assembly 57 can be inserted into the bushing opening 74 and through the bushing passage 75 to removably attach the check assembly 57 to the door bracket 52.

In embodiments, the door bracket 52 can be made from any suitable material. For example, in embodiments, the door bracket 52 is made from a suitable metal. In embodiments, the door bracket 52 is made from a metal that can withstand a cathodic electrodeposition finishing process. It will be understood that in other embodiments, the door bracket 52 can have a different construction and take different forms.

Referring to FIG. 3, in embodiments, the pivot base 55 is configured to receive therein a pivot mount 82 of the check assembly 57 such that the pivot mount 82 is removably attached to the pivot base 55. The illustrated pivot base 55 includes a body 90 and a retainer spring clip 92 movably mounted thereto. The body 90 defines an interior cavity 93 into which the pivot mount 82 is disposed. Once the pivot mount 82 is disposed within the body 90, the retainer spring clip 92 retentively engages the pivot mount 82 to removably attach the check assembly 57 to the pivot base 55.

In embodiments, the body 90 and the retainer spring clip 92 can be made from any suitable material. For example, in embodiments, the body 90 can be made from plastic, and the retainer spring clip 92 can be made from metal.

Referring to FIG. 4, the check assembly 57 is configured to be removably attached to the door bracket 52 and to the pivot base 55. In embodiments, the check assembly 57 is configured to hold a door of the service body in an open position and, once the door is moved from the open position, to move the door to the closed position. The illustrated check assembly 57 includes: a rod 83, a spring assembly 84 wrapped around the rod 83, the pivot mount 82 intermediately disposed along the rod 83, and a rod bushing 85 removably attached to the bent end 80 of the rod 83. The illustrated spring assembly 84 includes a pair of springs 87, 88 arranged such that the pivot mount 82 is disposed between the springs 87, 88. The springs 87, 88 have a diameter sized such that the coils of the springs 87, 88 do not contact the rod 83 and are configured to be compressed without buckling as the door moves from the closed position to the fully open position. The springs are configured 87, 88 to alternately bias the door in the open position and to urge the door to the closed position once the door has been moved from its open, retained position. In embodiments, any suitable check assembly can be used. It will be understood that in other embodiments, the check assembly 57 can have a different construction and take different forms.

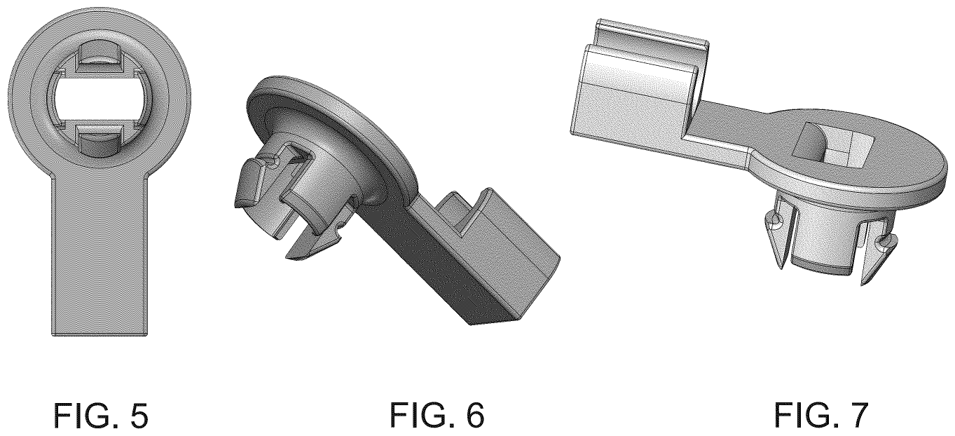

Referring to FIGS. 5-7, the rod bushing 85 of the check assembly 57 is shown. In embodiments, the rod bushing 85 is configured to be removably attached to the rod 83 and to the door bracket 52.

The illustrated rod bushing 85 includes a base 100, a pair of rod retainer clips 101, 102 projecting from a first face 104 of the base 100, and a bushing collar 105 with a pair of bracket retaining tabs 107, 108 projecting from a second face 110 of the base 100 that is in opposing relationship to the first face 104. The rod retainer clips 101, 102 are configured to be removably secured to a cylindrical portion of the rod. The retainer tabs are configured to retentively engage the collar 67 of the door bracket 52.

The illustrated rod bushing 85 comprises a dual release bushing. The rod 83 can be independently removed from the rod retainer clips 101, 102 of the rod bushing 85 even when the rod bushing 85 is mounted in the door bracket 52. The rod bushing 85 can also be removed from the door bracket 52 with the rod 83 still attached to the rod bushing 85.

The base 100 of the rod bushing 85 is generally planar and keyhole-shaped with the rod retainer clips 101, 102 disposed in a rectangular section 115 of the base 100. The bracket retaining tabs 107, 108 are disposed in a circular section 117 of the base 100. The base 100 defines a rod opening 118 in communication with the bushing collar 105.

The bushing collar 105 defines a rod passage 119 which is associated with the rod opening 118 defined by the base 100. In embodiments, the bent end 80 of the rod 83 can be inserted through the rod opening 118 of the based 100 and into the rod passage 119 of the bushing collar 105 when the rod retainer clips 101, 102 are secured to the rod 83.

The bracket retaining tabs 107, 108 of the bushing collar 105 cooperate together for removably attaching the rod bushing 85 to the door bracket 52. The bracket retaining tabs 107, 108 comprise a portion of the bushing collar 105 and are in opposing relationship with each other. The bracket retaining tabs 107, 108 are resiliently flexible such that they can be moved inwardly toward each other to allow the retaining tabs 107, 108 to fit through the bushing passage 785 of the door bracket 52 and then return to their normal position once respective locking portions 121, 122 of the retaining tabs 107, 108 pass through the bushing passage 75 of the door bracket 52. The respective locking portions of each retaining tab 107, 108 is configured to retentively engage the collar 67 of the door bracket 52 to removably attach the rod bushing 85 to the door bracket 52.

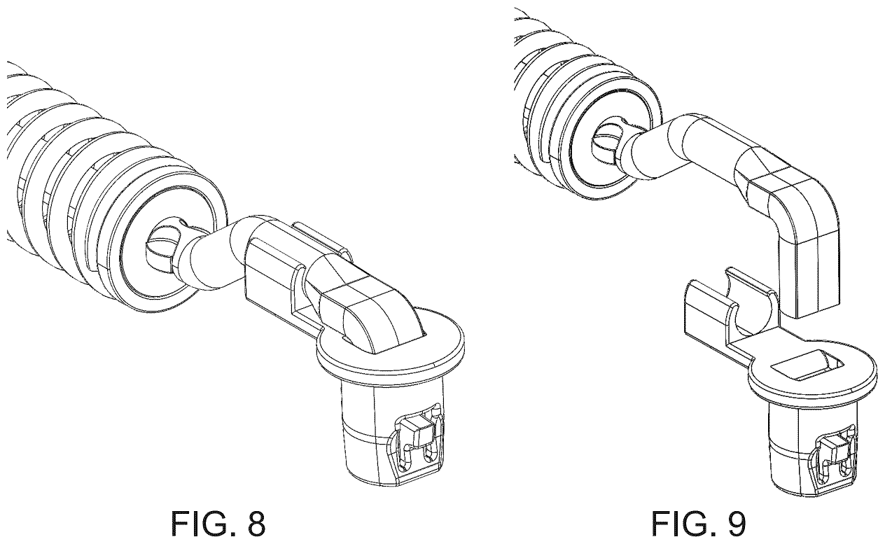

Referring to FIGS. 8 and 9, the illustrated rod opening 118 is generally rectangular in cross-section and is complementary to the shape of the bent end 80 of the rod 83. To secure the rod bushing 85 to the rod 83, the rod retainer clips 101, 102 can be secured to the cylindrical portion 112 of the rod 83. The rod retainer clips 101, 102 are resiliently flexible to permit the rod 83 to be pushed through the gap defined between the distal ends 124, 125 of the rod retainer clips 101, 102 and to return to their normal position to wrap over the cylindrical portion 112 of the rod 83 to secure the rod bushing 85 to the rod 83. The rod 83 can be secured to the rod bushing 85 such that a rectangular portion 127 of the bent end 80 of the rod 83 extends through the rod opening 118 of the base 100 and into the rod passage 119 of the bushing collar 105.

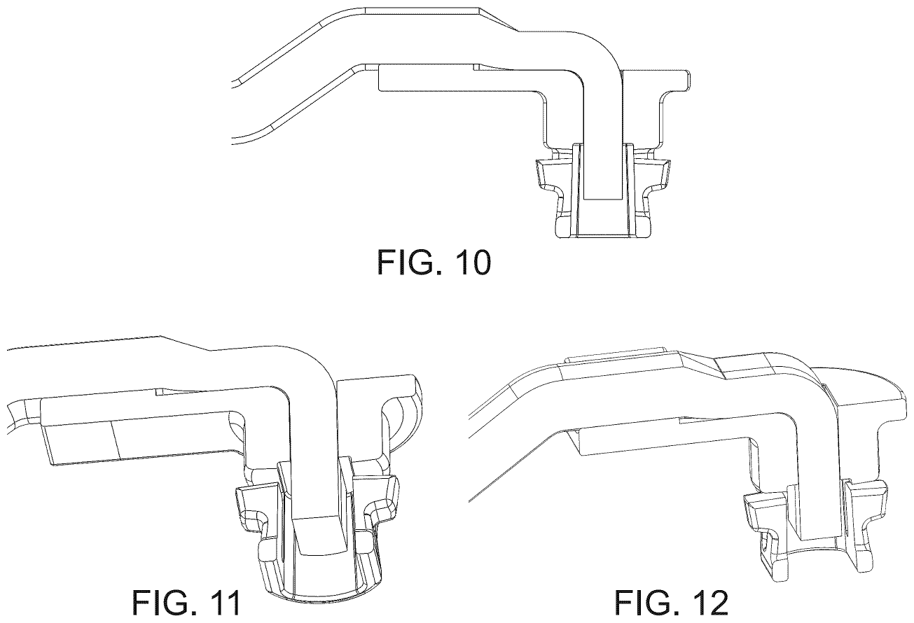

Referring to FIGS. 10-12, in the illustrated embodiment, an exterior surface 130 of each bracket retaining tabs 107, 108 includes a locking portion 132 projecting radially outwardly. Each locking portion 132 is configured to engage the collar 67 of the door bracket 52 to secure the rod bushing 85 to the door bracket 52. The rod passage 119 of the bushing collar 105 is configured such that the bracket retaining tabs 107, 108 can be moved inwardly toward each other to permit the rod bushing 85 to be removed from the door bracket 52 while the rod 83 is secured to the rod bushing 85 via the rod retainer clips 101, 102. The illustrated rod passage 119 flares outwardly along its longitudinal axis moving from the base 100 toward a distal end 134 of the bracket retaining tabs 107, 108.

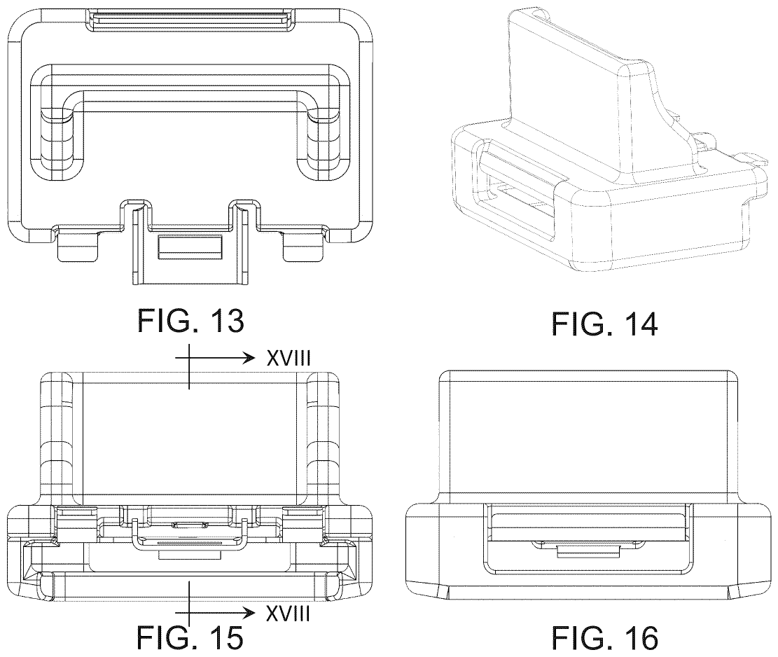

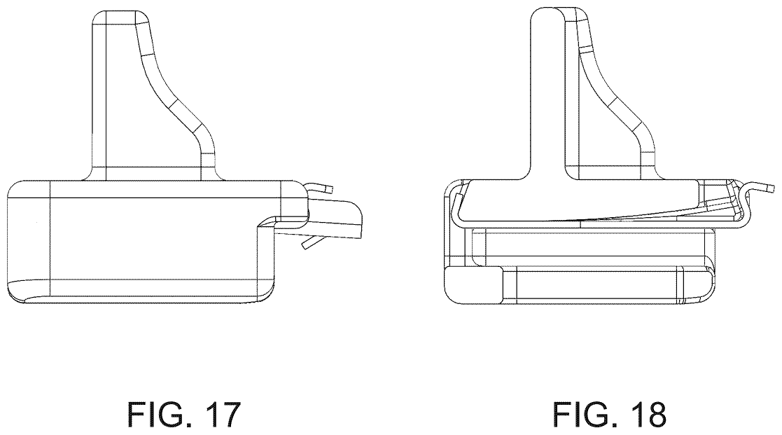

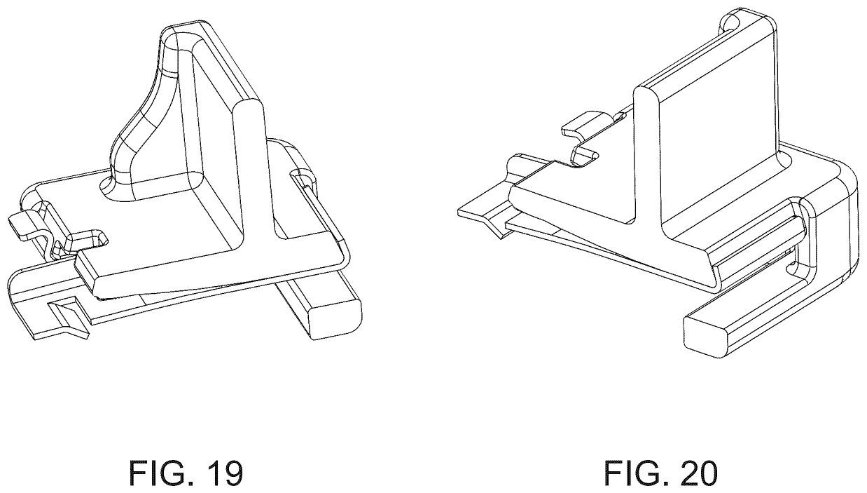

Referring to FIGS. 13-20, the pivot base 55 of the door retainer assembly 50 of FIG. 1 is shown. The pivot base 55 includes the body 90 and the retainer spring clip 92 movably mounted thereto.

The body 90 of the pivot base 55 includes a base 94, which defines the cavity 93 therein, and a mounting upright 95 configured to be secured to the doorframe 56 of the service body 54. The cavity 93 of the pivot base 55 is configured to accommodate the retainer spring clip 92 and the pivot mount 82 of the check assembly 57. The base 94 defines a mouth 97 in communication with the cavity 93 and through which the pivot mount 82 of the check assembly 57 can be inserted so that the pivot mount 82 is disposed within the cavity 93. The base 94 defines a clip opening 98 in communication with the cavity 93 and through which access to a mounting end 100 of the retainer spring clip 92 is provided. The base 94 includes a mounting lip 103 extending across the clip opening 98 and configured to mountingly receive the mounting end 100 of the retainer spring clip 92. The mounting upright 95 includes a weld tab 104 projecting from the base 94 and a pair of support arms 106, 107 respectively disposed at the ends 108, 109 of the weld tab 104 to help provide structural support to the weld tab 104.

The retainer spring clip 92 includes the mounting end 100, a pair of retention tabs 111, 112, and a lock tab 114. The mounting end 100 wraps around the mounting lip 103 of the base 100 to fix the mounting end 100 of the retainer spring clip 92 to the base 94 of the body 90 of the pivot base 55. The retention tabs 111, 112 are in flanking relationship to the lock tab 114 and, similar to the mounting end 100, are wrapped around a sloped edge 115 of the mouth 97 of the base 94 to help secure the retainer spring clip 92 to the body 90. The lock tab 114 is interposed between the retentions tabs 111, 112 and is in opposing relationship to the mounting end 100. The lock tab 114 extends from the mouth 97 of the base 94 of the body 90 and is movable between a downward, locked position and an upward, unlocked position. The lock tab 114 includes a stop 117 projecting downwardly therefrom which is configured to engage the pivot mount 82 when the pivot mount 82 is disposed within the cavity 93 to removably attach the pivot mount 82 to the pivot base 55. The retainer spring clip 92 is made from a suitable spring metal and is configured such that the locking tab 114 of the retainer spring clip 92 is biased toward the locked position.

Referring to FIGS. 14 and 16, in embodiments, the clip opening 98 of the base 94 of the body 90 is configured such that there is a slot defined between the retainer spring clip 92 and the body 90 sized to permit a screwdriver blade, or similar flat blade, to be inserted therein to drive the retainer spring clip 92 upward to the unlocked position to allow the pivot mount 82 to be removed from the pivot base 55.

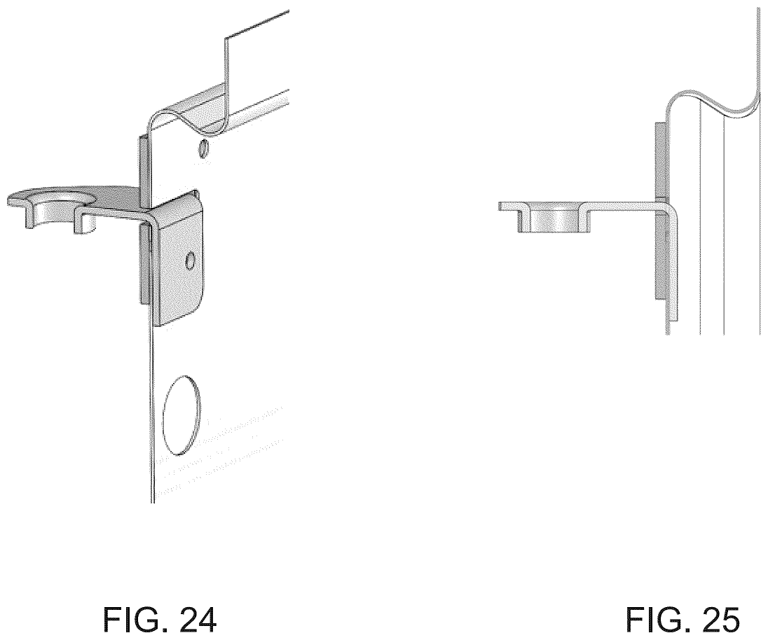

Referring to FIGS. 21-25, in embodiments, a door retainer assembly 50 constructed according to principles of the present disclosure can be mounted to a service body 54 which is configured to be installed on a vehicle. In embodiments, a service body 54 constructed according to principles of the present disclosure can have any suitable construction, such as those that are commercially-available as will be appreciated by one skilled in the art. The service body 54 can be used to store a variety of materials and/or tools suitable for use in an intended application or service.

In embodiments, the service body 54 includes an enclosure with an outer shell 120 and at least one door 53. In embodiments, the service body 54 includes an enclosure having an outer shell and at least two doors.

The illustrated outer shell 120 of the service body 54 is shown with some of the panel walls removed for illustrative purposes. It will be understood that embodiments of the service body include an enclosure that defines a covered interior storage space. The illustrated service body 54 includes the door 53 and the doorframe 56. The doorframe 56 includes a top jamb 121, a bottom jamb 122, a left jamb 123, and a right jamb 124. The jambs 121-124 bound and define an enclosure opening 125.

The door 53 selectively covers the enclosure opening 125 of the doorframe 56 and is moveable over a range of travel between a closed position and a range of open positions. The door 53 is configured to cover the enclosure opening 125 when in the closed position. The door 53 is preferably rotatably mounted to the doorframe 56 by a hinge 127. The hinge 127 is mounted to the right jamb 124 of the doorframe 56 and to the door 53. In embodiments, the hinge 127 extends substantially the full height of the door 53.

While loading and unloading the service body 54, it may be desirable that the door 53 remains in an open position. In embodiments, the service body 54 includes the door retainer assembly 50 to selectively retain the door 53 in an open position. In embodiments, at least one door of the service body can have associated therewith a door retainer assembly 50 constructed according to principle of the present disclosure to selectively retain the door 53 in the open position, as shown in FIG. 21.

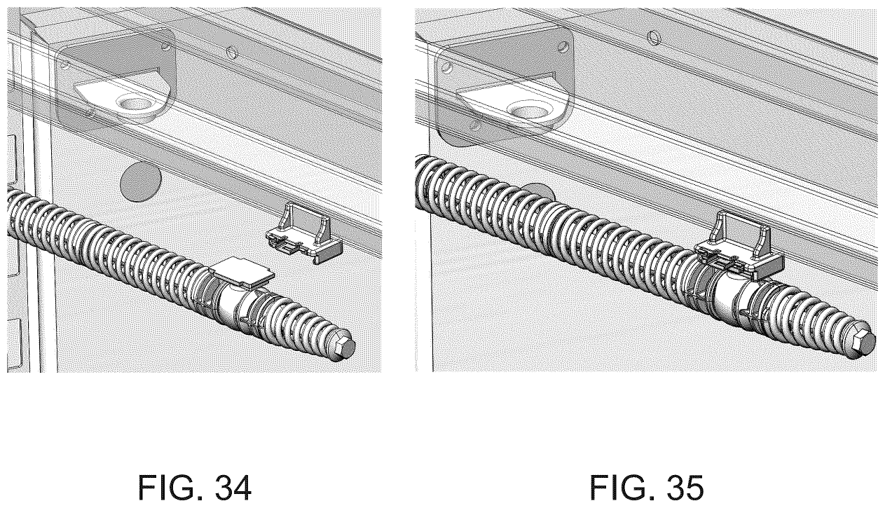

The door bracket 52 of the door retainer assembly 50 is mounted to an inner surface 129 of the door 53. The pivot base 55 of the door retainer assembly 50 is secured to an interior surface 131 of the top jamb 121 (see also FIGS. 34-39). The check assembly 57 is removably attached to the door bracket 52 via the rod bushing 85 and to the pivot base 55 via the pivot mount 82.

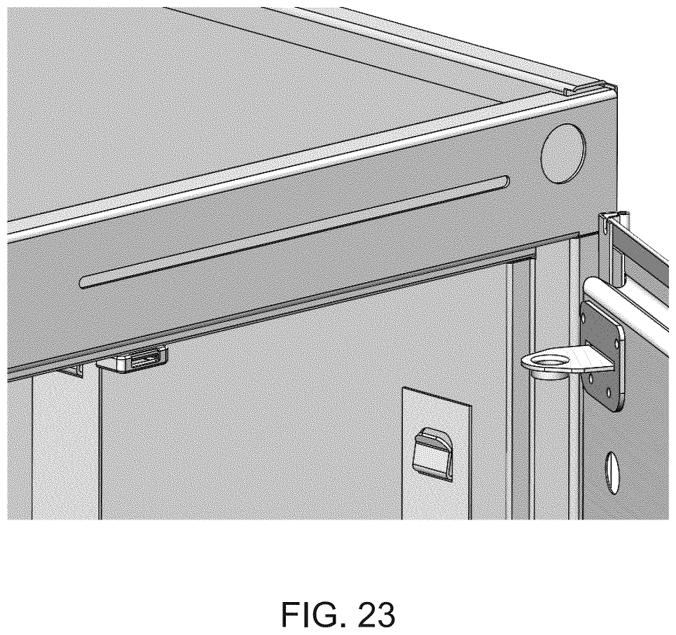

Referring to FIG. 23, the check assembly 57 has been detached from the door bracket 52 and the pivot base 55. Any suitable technique can be used to secure the door bracket 52 to the door 53 of the service body 54. In the illustrated embodiment, the door bracket 52 is mounted to the inner surface 129 of the door 53 by a plurality of rivets 134. Any suitable technique can be used to secure the pivot base 55 to the doorframe 56 of the service body 54. In the illustrated embodiment, the pivot base 55 is secured to the inner surface 131 of the doorframe 56 via a weld.

Referring to FIGS. 23-25, in the illustrated embodiment, a square support plate 137 with four mounting holes 138 defined therethrough is mounted to the door skin via rivets at the four mounting hole locations. The L-shaped door bracket 52 is riveted to the square support plate 137 and the inner door skin through the bottom two mounting holes of the square support plate 137 with the inner door skin sandwiched between the door mounting flange 62 and the square support plate 137. Openings in the support plate 137 and the inner door skin are configured such that the mounting flange 62 of the door bracket 52 can be inserted therethrough with the rod mounting flange 64 extending inwardly from the support plate 137 into the storage area of the service body 54.

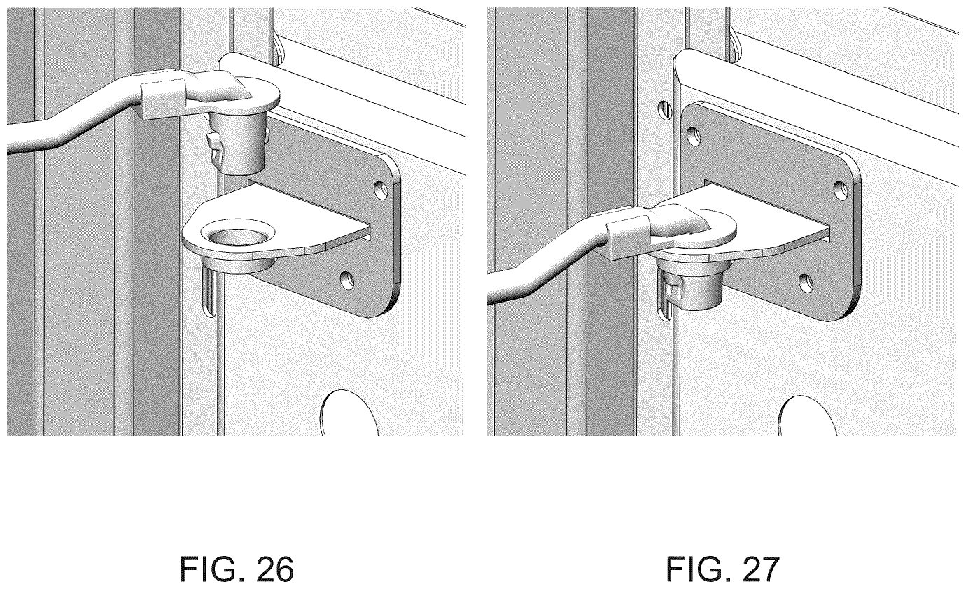

Referring to FIGS. 26 and 27, in a first attachment sequence of the bracket end of the check assembly 57 to the door bracket 52, the rod bushing 85 is secured to the rod 83 before being removably attached to the door bracket 52. The rod bushing 85 can be inserted into the bushing passage 75 of the door bracket rod mounting flange 64. Locking portions 121, 122 of the retainer tabs 107, 108 of the rod bushing 85 are interengaged with the collar 67 of the door bracket 52 to secure the rod bushing 85 to the door bracket 52.

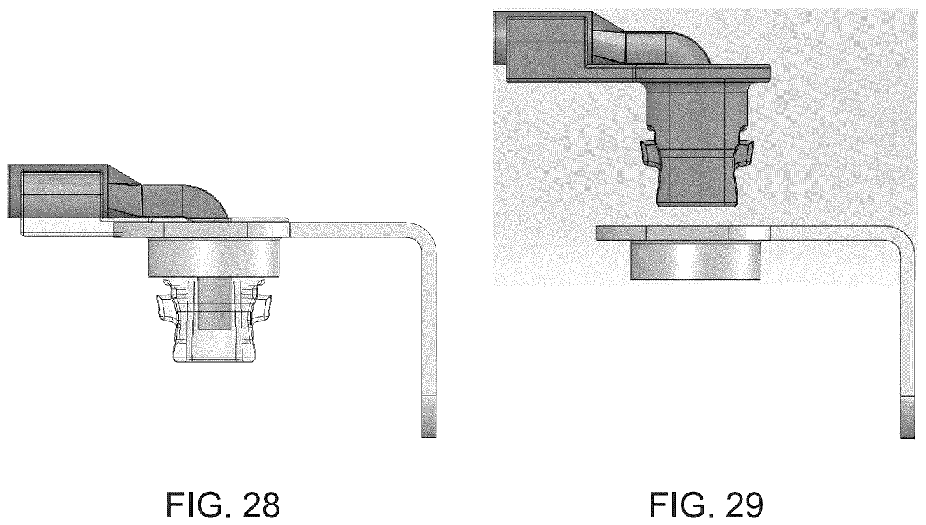

Referring to FIGS. 28 and 29, a first detachment sequence of the bracket end of the check assembly 57 from the door bracket 52 is shown. The bent end 80 of the rod 83 includes a pair of flat, planar surfaces 141, 142 in opposing relationship to each other which provide clearance between the rod 83 and an inner surface 144 of the rod bushing 85 that defines the rod passage 119. The planar surfaces 141, 142 of the rod 83 are mated against the portion of the inner surface 144 of the rod bushing 85 that underlie the retainer tabs 107, 108. The clearance permits the tabs 107, 108 to be pinched inward toward each other to allow the rod bushing 85 to be removed from the door bracket 52 without disengaging the rod 83 from the rod bushing 85.

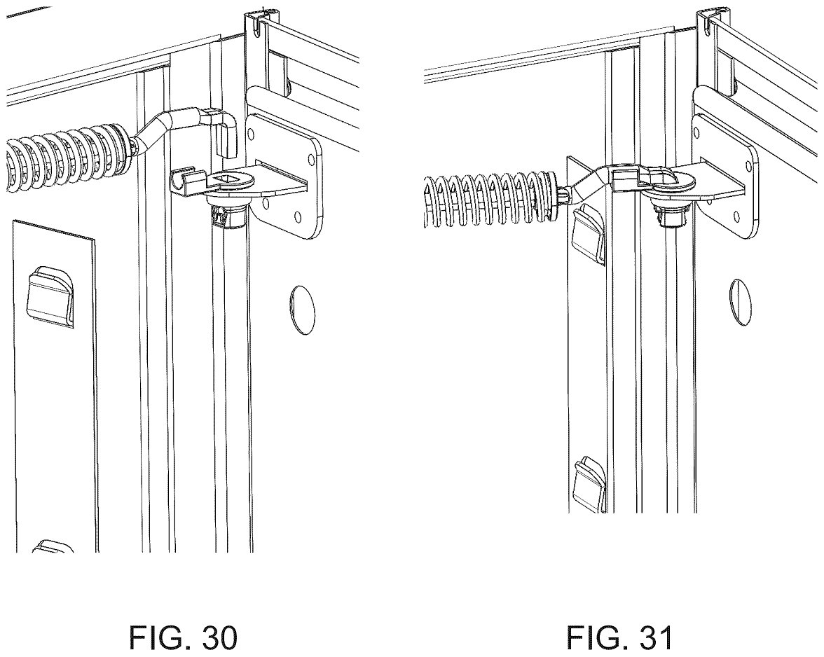

Referring to FIGS. 30 and 31, a second attachment sequence of the bracket end of the check assembly 57 to the door bracket 52 is shown. In this attachment sequence, the rod bushing 85 is attached to the door bracket 52 on its own without the rod 83 being engaged with the rod bushing 85. After the rod bushing 85 is mounted to the door bracket 52, the cylindrical portion 112 of the bent end 80 of the rod 83 can be snapped into the rod retainer clips 101, 102 of the rod bushing 85. The planar surfaces 141, 142 of the bent end 80 of the rod 83 permit the bent end 80 to be inserted into the rod passage 119 defined by the rod bushing 85. The clearance between the bent end 80 of the rod 83 and the rod bushing 85 permits the rod 83 to be inserted into the rod passage 119 of the rod bushing 85 with the rod bushing 85 removably attached to the door bracket 52.

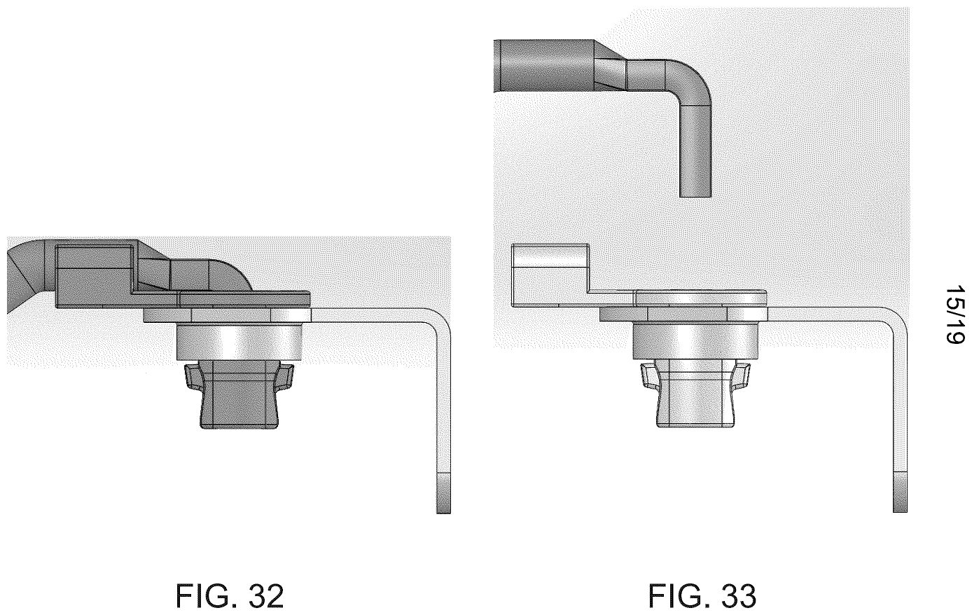

Referring to FIGS. 32 and 33, a second detachment sequence of the bracket end of the check assembly 57 from the door bracket 52 is shown. The clearance between the bent end 80 of the rod 83 and the rod bushing 85 permits the rod 83 to be removed from the rod bushing 85 without disengaging the rod bushing 85 from the door bracket 52.

Referring to FIGS. 34 and 35, an attachment sequence of a pivot mount 82 of the check assembly 57 to the pivot base 55 is shown. The pivot base 55 is mounted to the doorframe 56 of the service body 54. As shown in FIG. 34, the pivot base 55 is welded to the interior surface 131 of the top jamb 121 of the service body 54. To mount the check assembly 57 to the pivot base 55, the pivot mount 82 is inserted into the mouth 97 of the pivot base 55 until the retainer spring clip 92 of the pivot base 55 locks back into place after the pivot mount 82 clears the lock tab 114.

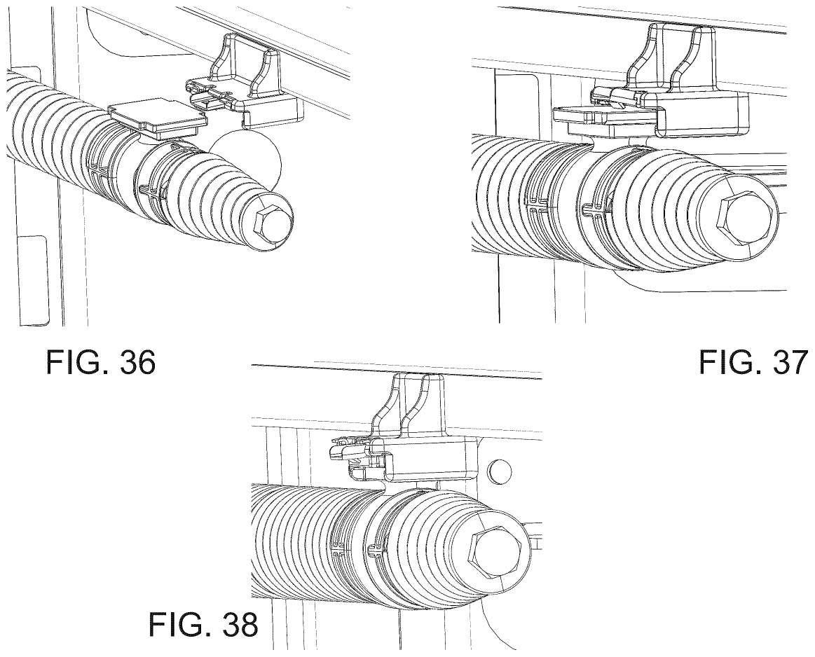

FIGS. 36-38 are detail views illustrating the attachment sequence of the pivot mount 82 of the check assembly 57 to the pivot base 55. FIG. 36 shows the pivot mount 82 aligned with the mouth 97 of the pivot base 55. FIG. 37 shows the retainer spring clip 92 of the pivot base 55 in an intermediate position with the lock tab 114 riding along the top of the pivot mount 82 as the pivot mount 82 is inserted into the mouth 97 of the pivot base 55. FIG. 38 shows the retainer spring clip 92 of the pivot base 55 snapped back into place after the pivot mount 82 is inserted into the mouth 97 of the pivot base 55 a sufficient amount so that the pivot mount 82 clears the lock tab 114 of the retainer spring clip 92 and it moves back to the locked position so that the stop 117 engages the pivot mount 82 to removably attach the pivot mount 82 to the pivot base 55.

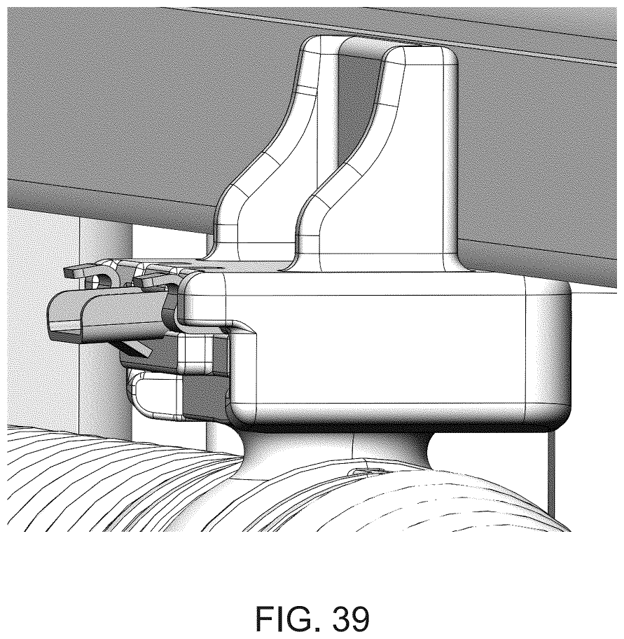

Referring to FIG. 39, the pivot mount 82 of the check assembly 57 is releasably mounted to the pivot base 55. The retainer spring clip 92 secures the check assembly 57 inside the pivot base 55 so that the check assembly 57 is pivotally secured to the doorframe 56 of the service body 54.

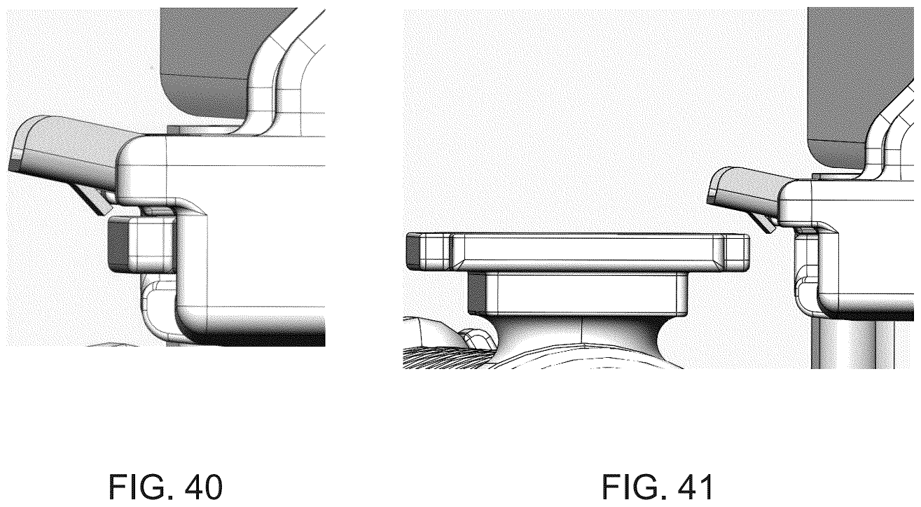

Referring to FIGS. 40 and 41, to detach the pivot mount 82 of the check assembly 57 from the pivot base 55, the lock tab 114 of the retainer spring clip 92 can be manually moved upward by an operator to the unlocked position so that the stop 117 of the lock tab 114 is in offset relationship to the pivot mount 82. With the retainer spring clip 92 moved to the unlocked position, the pivot mount 82 can be slid out of the mouth 97 of the pivot base 55 to detach the check assembly 57 from the pivot base 55. Accordingly, embodiments of a door retainer assembly 50 constructed according to principles of the present disclosure permits easy detachment of the check assembly 57 during activities such as painting or powder coating the service body either at first manufacture or during periodic maintenance thereof. The spring-loaded retainer clip 92 allows for easy installation and removal of the check assembly 57 from the service body 54 to prevent it from being exposed to the chemicals and heat associated with the service body coating process as well as secondary priming/painting operations.

In embodiments, the components of the door retainer assembly can be made from any suitable material and made using any suitable technique. In embodiments, the door retainer assembly can be made from a plurality of components that are assembled together to provide the functionality described herein. In embodiments, the door retainer assembly can have any configuration suitable for the intended application(s) of the service body for which it is provided and for a predetermined set of door and frame combinations.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. A door retainer assembly comprising:
a door bracket for mounting to a door of a service body, the door bracket comprising an L-shaped bracket;
a pivot base for mounting to a doorframe of the service body; and
a check assembly configured to be removably attached to the door bracket and the pivot base, and the check assembly configured to selectively hold the door in an open position.

2. The door retainer assembly according to claim 1, wherein the door bracket includes a door mounting flange for mounting the door bracket to the door, a rod mounting flange projecting from an end of the door mounting flange, and a collar extending from the rod mounting flange for removably mounting the check assembly to the door bracket, the rod mounting flange defining a bushing opening that is in communication with a bushing passage defined by the collar.

3. The door retainer assembly according to claim 2, wherein the door mounting flange defines a plurality of mounting holes.

4. The door retainer assembly according to claim 1, wherein the check assembly includes a rod, a rod bushing, and a pivot mount, the rod including a bent end to which the rod bushing is removably attached, the bend end and the rod bushing sized for inserting into the bushing opening and through the bushing passage to removably attach the check assembly to the door bracket.

5. The door retainer assembly according to claim 4, wherein the pivot base is configured to receive therein the pivot mount of the check assembly such that the pivot mount is removably attached to the pivot base.

6. The door retainer assembly according to claim 5, wherein the pivot base includes a body and a retainer spring clip movably mounted thereto, the body defines an interior cavity into which the pivot mount is disposed such that the retainer spring clip retentively engages the pivot mount to removably attach the check assembly to the pivot base.

7. The door retainer assembly according to claim 4, wherein check assembly includes a spring assembly having a pair of springs wrapped around the rod, the pivot mount intermediately disposed along the rod between the pair of springs.

8. The door retainer assembly according to claim 4, wherein the rod bushing includes a base, a pair of rod retainer clips projecting from a first face of the base, and a bushing collar with a pair of bracket retainer tabs projecting from a second face of the base that is in opposing relationship to the first face, wherein the retainer clips are removably secured to a cylindrical portion of the rod, and wherein the retainer tabs retentively engage the collar of the door bracket.

9. The door retainer assembly according to claim 8, wherein the bushing collar defines a rod passage associated with the rod opening defined by the base, the bent end of the rod inserted through the rod opening and into the rod passage with the retainer clips secured to the rod, the retainer clips being resiliently flexible to permit the rod to be pushed through the gap defined between a respective distal end of the retainer clips and to return to wrap over the cylindrical portion of the rod to secure the rod bushing to the rod.

10. The door retainer assembly according to claim 8, wherein the retaining tabs of the bushing collar cooperate together for removably attaching the rod bushing to the door bracket, the retainer tabs comprising a portion of the bushing collar and being in opposing relationship with each other, the retainer tabs being resiliently flexible such that the retainer tabs are movable inwardly toward each other to allow the retainer tabs to fit through the bushing passage of the door bracket and to return once locking portions of the retainer tabs pass through the bushing passage of the door bracket, and a respective locking portions of each retainer tab being configured to retentively engage the collar of the door bracket to removably attach the rod bushing to the door bracket.

11. A service body for a vehicle, the service body comprising:
a door;
a doorframe;
a door retainer assembly, the door retainer assembly including:
a door bracket, the door bracket mounted to the door, the door bracket comprising an L-shaped bracket,
a pivot base, the pivot base mounted to the doorframe, and
a check assembly, the check assembly removably attached to the door bracket and the pivot base, and the check assembly configured to selectively hold the door in an open position.

12. The service body according to claim 11, wherein the door bracket of the door retainer assembly includes a door mounting flange for mounting the door bracket to the door, a rod mounting flange projecting from an end of the door mounting flange, and a collar extending from the rod mounting flange for removably mounting the check assembly to the door bracket, the rod mounting flange defining a bushing opening that is in communication with a bushing passage defined by the collar.

13. The service body according to claim 12, wherein the door mounting flange defines a plurality of mounting holes.

14. The service body according to claim 11, wherein the check assembly of the door retainer assembly includes a rod, a rod bushing, and a pivot mount, the rod including a bent end to which the rod bushing is removably attached, the bend end and the rod bushing sized for inserting into the bushing opening and through the bushing passage to removably attach the check assembly to the door bracket.

15. The service body according to claim 14, wherein the pivot base of the door retainer assembly is configured to receive therein the pivot mount of the check assembly such that the pivot mount is removably attached to the pivot base.

16. The service body according to claim 15, wherein the pivot base of the door retainer assembly includes a body and a retainer spring clip movably mounted thereto, the body defines an interior cavity into which the pivot mount is disposed such that the retainer spring clip retentively engages the pivot mount to removably attach the check assembly to the pivot base.

17. The service body according to claim 14, wherein check assembly of the door retainer assembly includes a spring assembly having a pair of springs wrapped around the rod, the pivot mount intermediately disposed along the rod between the pair of springs.

18. The service body according to claim 14, wherein the rod bushing of the door retainer assembly includes a base, a pair of rod retainer clips projecting from a first face of the base, and a bushing collar with a pair of bracket retainer tabs projecting from a second face of the base that is in opposing relationship to the first face, wherein the retainer clips are removably secured to a cylindrical portion of the rod, and wherein the retainer tabs retentively engage the collar of the door bracket.

19. The service body according to claim 18, wherein the bushing collar of the door retainer assembly defines a rod passage associated with the rod opening defined by the base, the bent end of the rod inserted through the rod opening and into the rod passage with the retainer clips secured to the rod, the retainer clips being resiliently flexible to permit the rod to be pushed through the gap defined between a respective distal end of the retainer clips and to return to wrap over the cylindrical portion of the rod to secure the rod bushing to the rod.

20. The service body according to claim 18, wherein the retaining tabs of the bushing collar cooperate together for removably attaching the rod bushing to the door bracket, the retainer tabs comprising a portion of the bushing collar and being in opposing relationship with each other, the retainer tabs being resiliently flexible such that the retainer tabs are movable inwardly toward each other to allow the retainer tabs to fit through the bushing passage of the door bracket and to return once locking portions of the retainer tabs pass through the bushing passage of the door bracket, and a respective locking portions of each retainer tab being configured to retentively engage the collar of the door bracket to removably attach the rod bushing to the door bracket.
The check assembly is configured to selectively hold the door of the service body in an open position.
The rod bushing comprises a dual release bushing so that the rod of the check assembly can be independently removed from the rod bushing when the rod bushing is mounted in the door bracket and so that the rod bushing can be removed from the door bracket with the rod still attached to the rod bushing
